(19) United States
(12) Patent Application Publication
(10) Pub. No.: US 2020/0096049 A1
(43) Pub. Date: Mar. 26, 2020

(54) DEVICE FOR COMPENSATING FOR AXIAL PLAY

(71) Applicant: VALEO EMBRAYAGES, AMIENS CEDEX 2 (FR)

(72) Inventors: Gilles LEBAS, AMIENS CEDEX 2 (FR); Emmanuel COMMEINE, AMIENS CEDEX 2 (FR)

(73) Assignee: VALEO EMBRAYAGES, AMIENS CEDEX 2 (FR)

(21) Appl. No.: 16/495,319

(22) PCT Filed: Mar. 19, 2018
(86) PCT No.: PCT/FR2018/050655

§ 371 Date: Sep. 18, 2019

(30) Foreign Application Priority Data
Mar. 22, 2017 (FR) 1752363

(51) Int. Cl. F16D 3/06; B60K 17/02; F16D 3/60; F16D 13/70

(52) U.S. Cl. CPC F16D 3/06; B60K 17/02; F16D 2013/706; F16D 13/70; F16D 3/60

(57) ABSTRACT

A device for compensating for axial play, notably for a motor vehicle, having a first element that is intended to be fixed axially with respect to a crankshaft, a second element that is intended to be fixed axially with respect to a gearbox, play compensation means having tabs that are elastically deformable in the axial direction, said tabs extending circumferentially between the first and second elements so as to transmit a torque from one element to the other.

The present invention relates to an axial play compensation device, intended to equip a transmission chain of a motor vehicle, in particular a hybrid drive vehicle.

A transmission chain comprises in particular a gearbox and a clutch device mounted between a crankshaft of a heat engine, for example, and an input shaft of the gearbox.

The clutch device comprises a cover that is fixed axially relative to the gearbox. Moreover, a flexible steel plate is conventionally fixed onto the crankshaft of the engine. The flexible steel plate is coupled in rotation to the cover of the clutch device so as to ensure the transmission of the torque.

There is a dimensional mounting and/or manufacturing tolerance between the axial position of the crankshaft and of the flexible steel plate, on the one hand, and the axial position of the gearbox and of the cover of the clutch device, on the other hand. This tolerance can be of the order of several millimeters.

It is therefore important to compensate for this axial positioning defect between the flexible steel plate and the cover of the clutch device.

The document DE 10 2008 061 588 discloses the use of tongues that are elastically deformable in the axial direction, mounted between the reaction plate of a clutch device and an annular member linked to the crankshaft of an engine. First tongues are oriented circumferentially so as to be stressed by tension in a first direction of rotation of the crankshaft, called forward direction, and second tongues are oriented so as to be stressed by tension in a second direction of rotation of the crankshaft, called reverse direction.

The number of tongues in such a device must be optimized so as to reduce the costs, the weight and the bulk.

The aim of the invention is in particular to provide a simple, effective and economical solution to these problems.

To this end, it proposes an axial play compensation device, in particular for a motor vehicle, comprising a first element intended to be fixed axially relative to a crankshaft, a second element intended to be fixed axially relative to a gearbox, play compensation means comprising tongues that are elastically deformable in the axial direction, said tongues extending circumferentially between the first and second elements so as to transmit a torque from one element to the other, the first element being able to be displaced in the axial direction relative to the second element, against the elastic return force exerted by the tongues, first tongues being arranged so as to be stressed by tension, in a first direction of rotation of the first element, called forward direction, second tongues being arranged so as to be stressed by tension, in a second direction of rotation of the first element, called reverse direction, characterized in that the number of first tongues is greater than the number of second tongues.

The deformable tongues make it possible to couple the first element and the second element in rotation so as to be able to transmit a torque from one element to the other. Moreover, the tongues allow an axial travel between the elements so as to compensate for the axial play deriving from the dimensional mounting and/or manufacturing tolerances.

The forward direction corresponds to a transmission of the torque from the crankshaft to the gearbox. The torque that has to be transmitted through the device is greater in the forward direction than in the reverse direction.

The rotation in the reverse direction can in particular occur when the gearbox is in neutral position or the clutch is in declutched position and the engine is exerting a braking torque, called engine brake. In some applications, a rotation in the reverse direction can also occur in the case of reversal of the direction of rotation of the engine.

The difference between the number of the first tongues and the number of the second tongues makes it possible to best dimension the tongues used according to the maximum value of the torque to be transmitted, this maximum torque being greater in a case of operation in forward direction than in a case of operation in reverse direction.

The tongues can be arranged in groups, each group comprising a stack of several tongues.

The number of tongues per group can be identical or differ from one group to the other. Moreover, the form and the section of the tongues can be identical or different.

Each tongue can comprise a first end fixed to the first element by riveting and a second end fixed to the second element by riveting.

The first element can comprise holes for the engagement of fixing members, such as studs, for it to be fixed to the crankshaft. The second element can also comprise holes for the engagement of fixing members, such as rivets, for it to be fixed to the gearbox.

For each of the first and second elements, the ends of the first tongues can precede the holes for the engagement of the link members in the forward direction, such that they operate by tension.

For each of the first and second elements, the ends of the second tongues can precede the holes for the engagement of the link members in the reverse direction, such that they operate by tension.

Each hole for the engagement of the fixing member of the first or second element can be:

either framed circumferentially by an end of a first tongue and an end of a second tongue, or
framed circumferentially by an end of two first tongues.

Each hole for the engagement of fixing members of the first element can be arranged axially facing a hole for the engagement of fixing members of the second element.

The first element and/or the second element can comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

Said deformable zone can be capable of being deformed axially.

The deformable zone can thus participate in the compensation of the axial play.

The deformable zone can comprise an arched portion capable of being deformed by tension or by compression.

The deformable zone can take the form of a tab in the general form of a circular arc for example. The deformable zone can be made of a piece with the rest of the corresponding element. Said deformable zone can be obtained by cutting.

Only one of the first and second elements can be equipped with at least one deformable zone. Only the second tongues, that is to say the tongues stressed by tension in the reverse direction, can be linked to the corresponding element by a zone that is deformable in the circumferential direction and/or in the axial direction.

The invention can also relate to an axial play compensation device, in particular for a motor vehicle, comprising a first element intended to be fixed axially relative to a crankshaft, a second element intended to be fixed axially relative to a gearbox, play compensation means comprising tongues that are elastically deformable in the axial direction, said tongues extending circumferentially between the first and second elements so as to transmit a torque from one element to the other, the first element and/or the second element comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

The invention relates also to a transmission assembly comprising a flexible steel plate intended to be mounted on a crankshaft of an engine, a clutch device comprising a cover intended to be fixed axially relative to an input shaft of a gearbox, characterized in that it comprises a compensation device of the abovementioned type, the first element being fixed to the flexible steel plate, the second element being fixed to the cover of the clutch device.

The first element can be fixed to the flexible steel plate via studs, at least one of said studs comprising a head situated axially facing a rivet used to fix a second element onto the cover.

The head of the stud can then serve as bearing surface in the riveting operation.

Each stud can be capable of cooperating with a nut secured to the flexible steel plate, for example welded to the flexible steel plate.

The invention relates also to a method for mounting a transmission assembly of the abovementioned type, characterized in that it comprises a step consisting in riveting the second element onto the cover by the pressing of the corresponding rivet onto the head of the stud.

The invention will be better understood and other details, features and advantages of the invention will become apparent on reading the following description given by way of nonlimiting example with reference to the attached drawings in which:

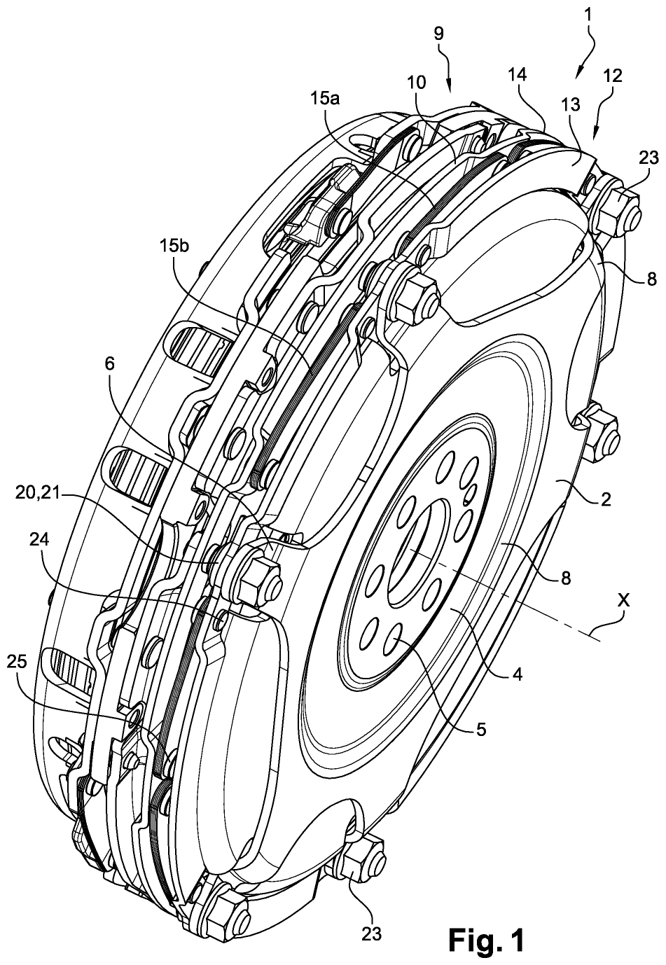

FIG. 1 is a perspective view of a transmission assembly according to a first embodiment of the invention,

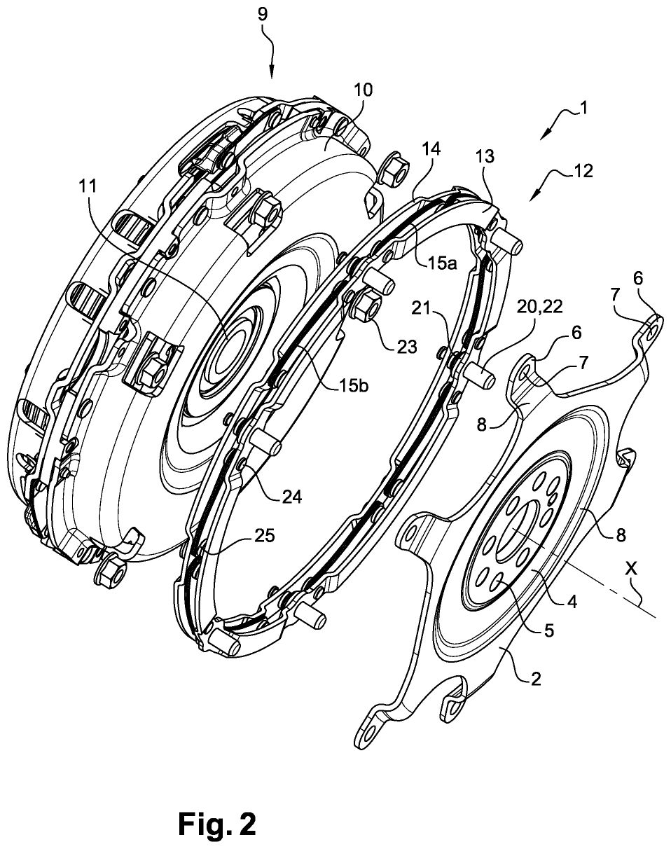

FIG. 2 is an exploded perspective view of the assembly of FIG. 1,

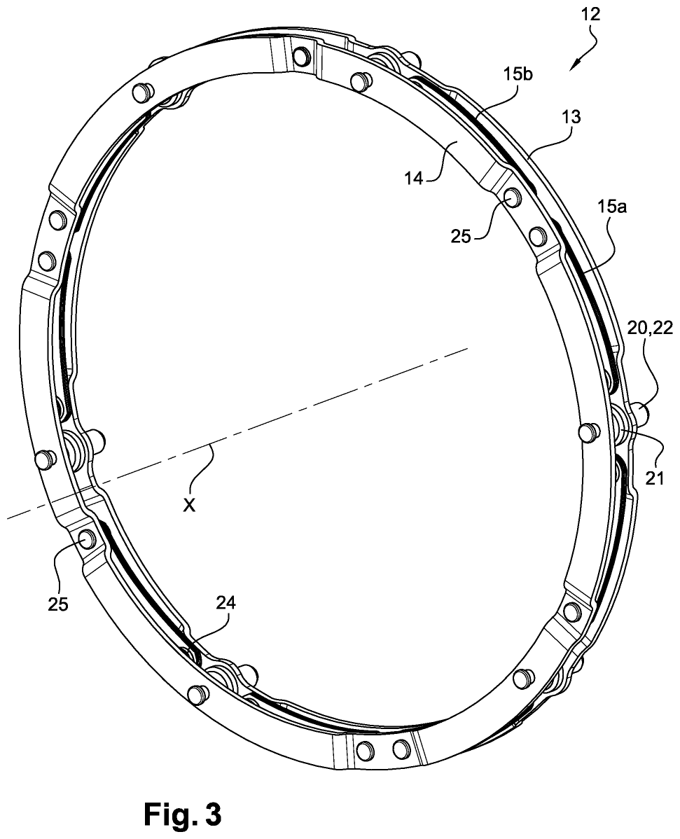

FIG. 3 is a perspective view of the axial play compensation device belonging to the assembly of FIGS. 1 and 2,

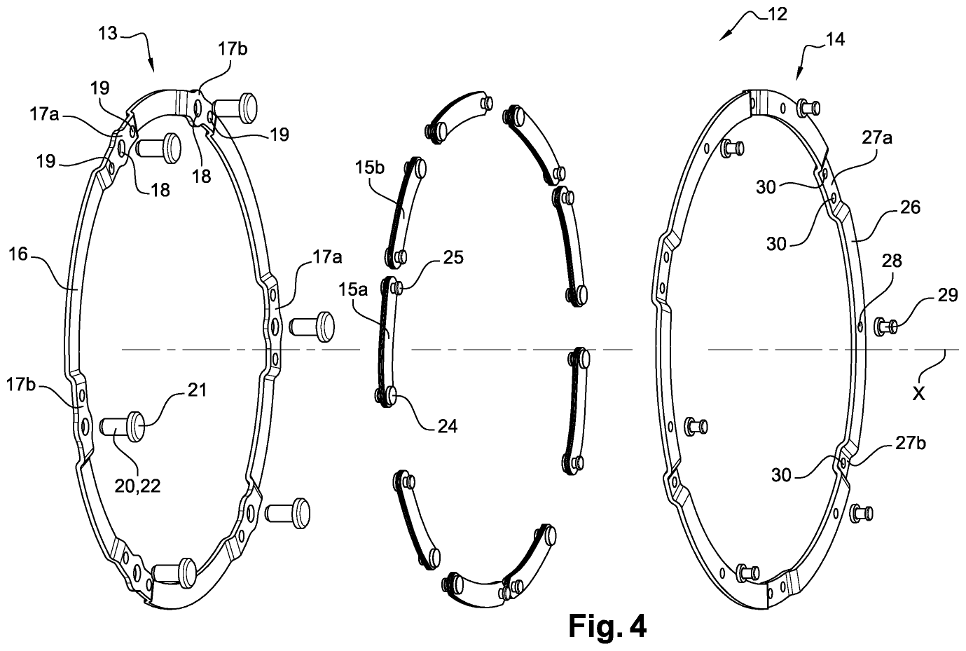

FIG. 4 is an exploded perspective view of the axial play compensation device,

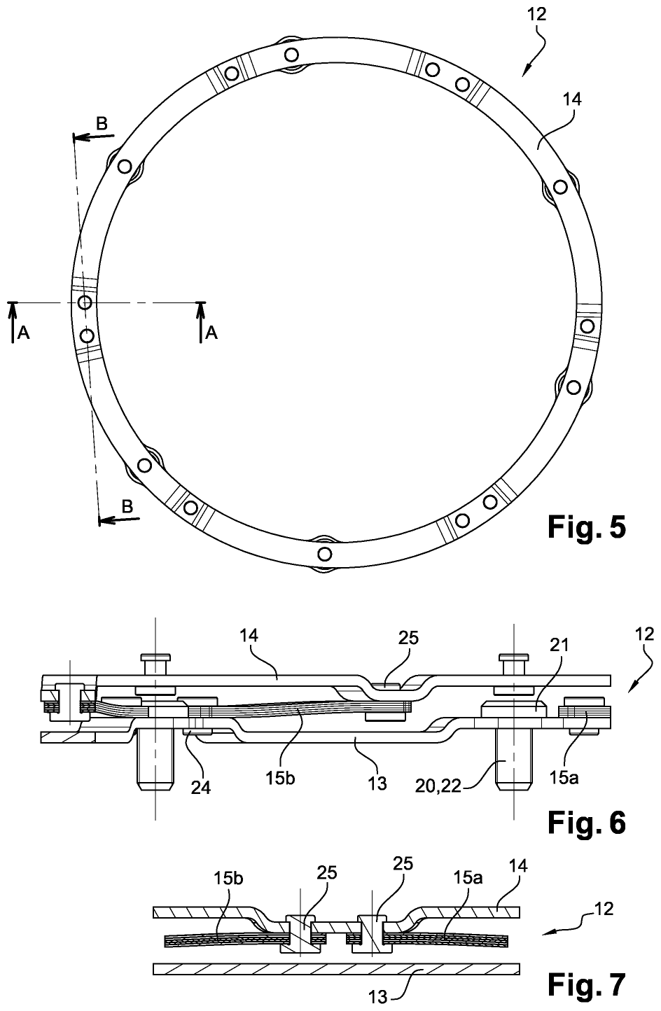

FIG. 5 is a front view of said device,

FIG. 6 is a half-view in cross section along the line A-A of FIG. 5,

FIG. 7 is a half-view in cross section along the line B-B of FIG. 5,

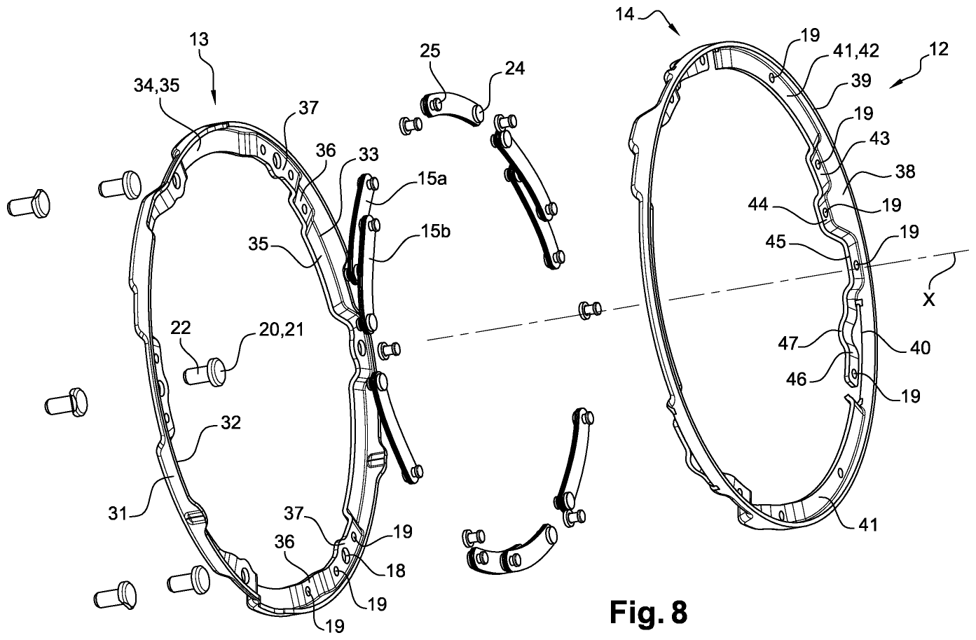

FIG. 8 is an exploded perspective view of a play compensation device according to a second embodiment of the invention,

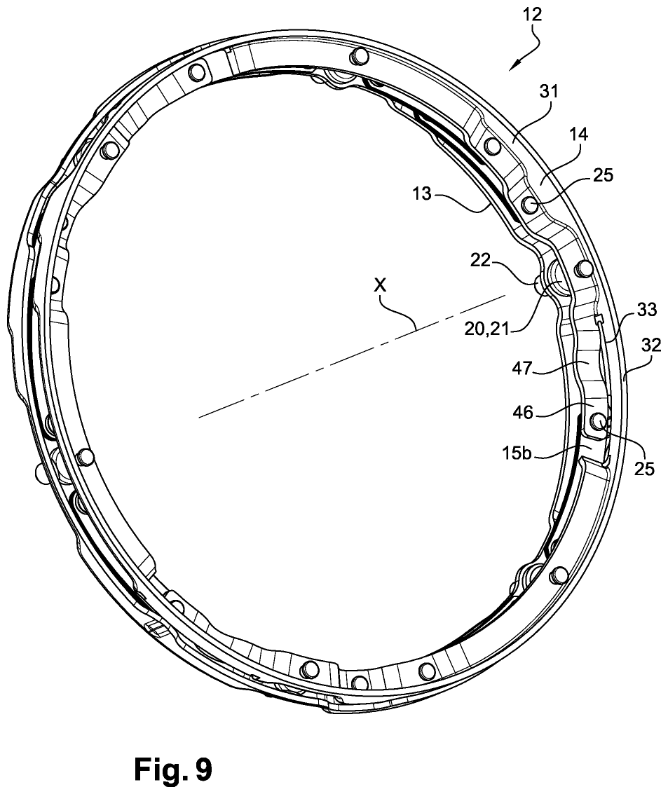

FIG. 9 is a perspective view of the device of FIG. 8,

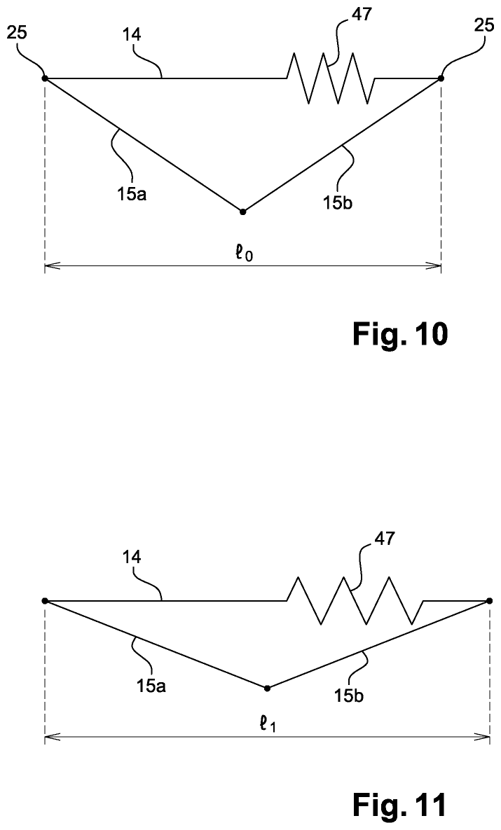

FIGS. 10 and 11 are schematic views of a part of the device of FIGS. 8 and 9.

FIGS. 1 and 2 represent a transmission assembly 1 intended to equip a motor vehicle, according to a first embodiment of the invention. This assembly 1 comprises a flexible steel plate 2 intended to be mounted on a crankshaft of an engine.

The flexible steel plate 2 comprises an annular part 4 of axis X, the radially internal periphery of which comprises holes 5 used for fixing onto a crankshaft of an internal combustion engine, via screws.

Tabs 6 extend radially outward from the annular part 4, each tab 6 comprises a fixing hole 7.

The tabs 6 and the annular part 4 comprise arched zones 8.

The tabs 6 and/or the annular part 4 are elastically deformable in the axial direction X.

The assembly 1 further comprises a clutch device 9 whose structure is known per se. This device 9 conventionally comprises a cover 10 forming the torque input, and a hub 11 forming the torque output. An input shaft of a gearbox is engaged in the hub 11 and is coupled in rotation therewith, for example via splines. The clutch device makes it possible to couple the cover 10 and the hub 11 in rotation, in a clutched position, and to decouple the cover 10 and the hub 11 in rotation, in a declutched position.

The axial position of the cover 10 is fixed relative to the input axis of the gearbox.

There is a dimensional mounting and/or manufacturing tolerance between the axial position of the crankshaft and of the flexible steel plate 2, on the one hand, and the axial position of the gearbox and of the cover 10 of the clutch device 9, on the other hand. This tolerance can be of the order of several millimeters, for example lying between 2 and 5 mm, here of the order of 3.5 mm.

In order to effectively compensate for this axial positioning defect between the flexible steel plate 2 and the cover 10 of the clutch device 9, the transmission assembly 1 comprises an axial play compensation device 12, inserted axially between the flexible steel plate 2 and the cover 10, and capable of transmitting a torque between the crankshaft and the gearbox, that is to say between the flexible steel plate 2 and the cover 10.

The compensation device 12 comprises a first annular element 13, a second annular element 14 and tongues 15a, 15b that are elastically deformable in the axial direction X, linking the first and second elements 13, 14.

As can be seen better in FIG. 4, the first element 13 comprises first zones 16 situated in a first radial plane and second zones 17a, 17b forming fixing zones, extending in a second radial plane, which is offset relative to the first radial plane toward the second element 14.

The number of the second zones 17a, 17b is for example six, and they are distributed in two groups. A first group comprises three fixing zones 17a each comprising three fixing holes 18, 19. A second group comprises three fixing zones 17b each comprising two fixing holes 18, 19.

The holes 18 are used for the engagement of studs 20, each stud 20 comprising a widened head 21 bearing on the corresponding second zone 17a, 17b, the head 21 being situated on the side of the second element 14.

The threaded part 22 of each stud 20 is engaged in the hole 7 of the corresponding tab 6 of the flexible steel plate 2 and cooperates with a nut 23 secured to said tab 6, for example welded to said tab 6.

The holes 19 are used for the engagement of rivets 24 that make it possible to fix the elastic tongues 15a, 15b onto the first element 13.

As can be seen better in FIG. 4, the second element 14 comprises first fixing zones 26 situated in a first radial plane and second fixing zones 27a, 27b, extending in a second radial plane, which is offset relative to the first radial plane toward the first element 13.

The number of the first fixing zones 26 is for example six and they each comprise a hole 28 used for the engagement of a rivet 29 making it possible to fix the second element 14 onto the cover 10 of the clutch device 9.

The number of the second fixing zones 27a, 27b is for example six and they are distributed in two groups. A first group comprises three fixing zones 27a each comprising two fixing holes 30. A second group comprises three fixing zones 27b each comprising one fixing hole 30.

The holes 30 are used for the engagement of rivets 25 making it possible to fix the elastic tongues 15a, 15b onto the second element 14.

More particularly, the compensation device 12 comprises first elastic tongues 15a and second elastic tongues 15b. Each type of tongue is arranged in the form of groups or of bundles, each group or bundle being composed of several stacked tongues.

The tongues 15a, 15b are deformable in the axial direction X.

In the example represented, each group is formed by five stacked tongues 15a, 15b. Obviously, the number of tongues 15a, 15b can be different and even vary from one group to the other. Each group can also be formed by one to ten tongues.

Each group of tongues 15a, 15b is linked to the first element 13, via one and the same rivet 24 engaged in holes of the tongues 15a, 15b and in a hole 19 of the first element 13, and to the second element 14, via one and the same rivet 25 engaged in holes of the tongues 15a, 15b and in a hole 30 of the second element 14.

The tongues 15a, 15b are globally planar, in this embodiment. Obviously, the form and the dimensions of the tongues 15a, 15b can vary, for example from one group of tongues to the other.

The tongues 15a, 15b extend circumferentially. The first tongues 15a are oriented so as to be stressed by tension in a first direction of rotation of the first element 13, called forward direction, the second tongues 15b being arranged so as to be stressed by tension, in a second direction of rotation of the first element 13, called reverse direction.

The first tongues 15a are formed by 6 groups of tongues and the second tongues 15b are formed by 3 groups of tongues. Here again, the number of groups can vary according to the applications.

Each widened head 21 of the studs 20 is situated axially facing one of the rivets 30 used for the fixing of the second element onto the cover 10. The widened head 21 of the stud 20 can thus serve as bearing surface in the corresponding riveting operation.

The deformable tongues 15a, 15b make it possible to couple the first element 13 and the second element 14 in rotation so as to be able to transmit a torque from one element to the other. Moreover, the tongues 15a, 15b allow an axial travel between the elements 13, 14 so as to compensate for the axial play deriving from the dimensional mounting and/or manufacturing tolerances.

The forward direction corresponds to a transmission of the torque from the crankshaft to the gearbox. The torque that has to be transmitted through the compensation device 12 is greater in the forward direction than in the reverse direction, which explains the greater number of groups of tongues 15a of the first type relative to the groups of tongues 15b of the second type.

FIGS. 8 and 9 illustrate a play compensation device 12 according to a second embodiment of the invention.

In this embodiment, the first element 13 comprises a cylindrical annular part 31 comprising a first axial end 32 situated on the side of the second element 14 and a second axial end 33 opposite the second element 14. A flange 34 extends radially inward from the second axial end 32 of the first element 13.

The flange 34 comprises first zones 35 extending in a first radial plane, second zones 36 extending in a second radial plane, third zones 37 extending in a third radial plane. Each second zone 36 comprises a fixing hole 19, intended for the engagement of a fixing rivet 23. Each third zone 37 comprises a hole 18 intended for the engagement of a stud 20 and two holes 19 intended for the engagement of fixing rivets 23.

The second element 14 comprises a cylindrical annular part 38 comprising a first axial end 39 opposite the first element 13 and a second axial end 40 situated on the side of the first element 13. Three flanges 41 in the form of an arc extend radially inward from the second axial end 39 of the second element 14.

Each flange 41 in the form of an arc extends circumferentially and comprises, in succession, from a first circumferential end to a second circumferential end, a first zone 42 extending in a first radial plane, a second zone 43 extending in a second radial plane, a third zone 44 extending in a third radial plane, a fourth zone 45 extending in the first radial plane and a fixing tab 46. Each zone 42, 43, 44, 45 comprises a fixing hole 19, intended for the engagement of a fixing rivet. The free end of the tongue also comprises a fixing hole 19 used for fixing tongues 15b.

The second radial plane is offset axially relative to the first radial plane toward the first element 13. The third radial plane is offset axially relative to the second radial plane toward the first element 13.

The fixing tab 46 extends circumferentially and is linked to the fourth zone 45, at its circumferential end opposite the free end. The fixing tab 46 is not directly linked to the cylindrical part 38 of the second element 14.

Each fixing tab 46 comprises an arched portion 47 situated between its free end and its end of linkage to the fourth zone 45. The arched portion 47 allows a deformation of the fixing tab 46 in the circumferential direction. The distance between the free end and the link end of the tab 46 is therefore capable of being modified by tension and/or by compression of the fixing tab 46, and more particularly of the arched zone 47.

The arched zone 47 has, in side view, the form of a circular arc. Other forms can be used.

Each fixing tab 46 is linked to tongues 15b of the second type, that is to say to tongues 15b stressed by tension in case of rotation of the first element 13 in the reverse direction.

In operation, the first and second elements 13, 14 are capable of being brought axially closer to one another, by opposing the axial return force exerted by the tongues 15a, 15b. FIGS. 10 and 11 respectively illustrate a separated state and a closer together state of the first and second elements 13, 14 linked by the first tongues 15a and by the second tongues 15b. The arched portion 47 is schematically represented by a spring in its figures.

When the first and second elements 13, 14 are brought closer together, the elongation of the fixing tab 46 by deformation of the arched portion 47 makes it possible to accompany the circumferential spacing between the fixing rivet 25 making it possible to fix the tongues 15a of the first type to the second element 13, on the one hand, and the fixing rivet 25 of the tongues 15b of the second type to the second element 14 (see FIG. 10). Since the arched portion 47 is elastically deformable, the latter behaves in the manner of a spring.

Obviously, such tabs 46 can also be used for the fixing of the tongues 15a of the first type. Moreover, such tabs 46 can be situated on the first element 13 and/or the second element 14.

1. An axial play compensation device for a motor vehicle, comprising a first element configured to be fixed axially relative to a crankshaft, a second element configured to be fixed axially relative to a gearbox, play compensation means comprising tongues that are elastically deformable in the axial direction, said tongues extending circumferentially between the first and second elements so as to transmit a torque from one element to the other, the first element being able to be displaced in the axial direction relative to the second element, against the elastic return force exerted by the tongues, first tongues being arranged so as to be stressed by tension, in a first direction of rotation of the first element, called forward direction, second tongues being arranged so as to be stressed by tension, in a second direction of rotation of the first element, called reverse direction, wherein the number of first tongues is greater than the number of second tongues.

2. The device according to claim 1, wherein the tongues are arranged in groups, each group comprising a stack of several tongues.

3. The device according to claim 1, wherein each tongue comprises a first end fixed to the first element by riveting and a second end fixed to the second element by riveting.

4. The device according to claim 1, wherein the first element and/or the second element comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

5. The device according to claim 4, wherein said deformable zone is capable of being deformed axially.

6. The device according to claim 4, wherein the deformable zone comprises an arched portion capable of being deformed by tension or by compression.

7. A transmission assembly comprising a flexible steel plate configured to be mounted on a crankshaft of an engine, a clutch device comprising a cover configured to be fixed axially relative to an input shaft of a gearbox, wherein the transmission assembly comprises a compensation device according to claim 1, the first element being fixed to the flexible steel plate, the second element being fixed to the cover of the clutch device.

8. The transmission assembly according to claim 7, wherein the first element is fixed to the flexible steel plate via studs, at least one of said studs comprising a head situated axially facing a rivet used to fix a second element onto the cover.

9. A method for mounting a transmission assembly according to claim 8, wherein the method comprises a step consisting in riveting the second element onto the cover by the pressing of the corresponding rivet onto the head of the stud.

10. The device according to claim 2, wherein each tongue comprises a first end fixed to the first element by riveting and a second end fixed to the second element by riveting.

11. The device according to claim 2, wherein the first element and/or the second element comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

12. The device according to claim 3, wherein the first element and/or the second element comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

13. The device according to claim 10, wherein the first element and/or the second element comprise a zone that is elastically deformable in the circumferential direction, said zone comprising a first end linked to the corresponding element and a second end used for fixing at least one tongue, said second end being capable of being displaced in the circumferential direction relative to the first end, by elastic deformation of the corresponding zone.

14. The device according to claim 11, wherein said deformable zone is capable of being deformed axially.

15. The device according to claim 5, wherein the deformable zone comprises an arched portion capable of being deformed by tension or by compression.
